(19) United States
(12) Patent Application Publication
(10) Pub. No.: US 2008/0261006 A1
(43) Pub. Date: Oct. 23, 2008

(54) Chemically-directed electrostatic self-assembly of materials

(76) Inventors: Logan S. McCarty, Somerville, MA (US); George M. Whitesides, Newton, MA (US); Adam Winkleman, Somerville, MA (US)

Correspondence Address: WILMERHALE/BOSTON, 60 STATE STREET, BOSTON, MA, 02109, US

(21) Appl. No.: 11/973,603

(22) Filed: Oct. 9, 2007

Related U.S. Application Data
(60) Provisional application No. 60/849,970, filed on Oct. 6, 2006.

(51) Int. Cl. B32B 7/02

(52) U.S. Cl. 428/212; 156/60

(57) ABSTRACT

A self-assembled article includes a surface comprising an chemical functionality having an immobilized charge; and a plurality of particles assembled on the surface of the core, said particles having a surface comprising an immobilized chemical functionality of a charge opposite that of the core.

### CROSS-REFERENCE TO RELATED APPLICATIONS

This application claims the benefit under 37 CFR 1.119(e) to co-pending U.S. Provisional Application No. 60/849,970 filed Oct. 6, 2006, the entire contents of which are incorporated by reference.

### STATEMENT AS TO FEDERALLY SPONSORED RESEARCH

This invention was made with Government Support under Contract Number W911NF-04-1-0170 awarded by the Army Research Office. The Government has certain rights in the invention.

### RELATED FIELD

This inventions relates to the self-assembly of materials. In particular, the invention relates to self-assembly of materials based on electrostatic charges.

### BACKGROUND

The term electret describes a material that demonstrates a persistent dielectric polarization. Space-charge electrets are typically formed by adding charge onto the surface or into the bulk of a material with an electron-beam, an ion-beam, corona discharge from a high-voltage electrode or direct contact with a charged electrode. Ionic electrets bear a long-lived electrostatic charge due to an imbalance between the number of cationic and anionic charges in the material. Electrets may form by contact charging or contact electrification, a phenomenon in which an electrical charge is transferred between two dissimilar materials (solids) when they are brought into contact with one another. For example, contact between two different metals can result in the transfer of electrons from one metal to the other or contact between a material with covalently-bound ions and mobile counterions results in the transfer of some of the mobile ions to the contacted surface.

There are many instances in which electrostatic charging is undesirable, for example, the flow of powders can generate static charges that inhibit free flow and complicate powder processing. Static charge accumulated in a human can harm sensitive electronics.

However, electrets have found use in technologies that make a powder or liquid adhere selectively to an object. For example, photocopying, an example of dry electrostatic self-assembly, uses corona discharge form a high-voltage electrode to create a charge on the imaging drum and uses contact electrification to create an opposite charge on the toner particles. The charged toner particles selectively assemble on the charged pattern of the imaging drum. Electrostatic separations techniques can separate coal from various impurities and powders composed of different plastics in plastic recycling. Electrostatic powder coating and electrostatic spray paining coat large objects with a uniform layer of plastic powder of paint.

New methods and uses of charged particles are sought.

### SUMMARY

Materials and methods for the chemically-directed electrostatic self-assembly of materials are described. The self-assembled structures find use as encapsulants for storing and/or releasing materials within a self-assembled structure; e.g., food or drug, as a catalyst having a highly controlled reactive surface, and/or in powder manufacture to improve powder flow.

In one aspect, a material having immobilized, e.g., covalently bound, ionic functional groups of one type of charge and a mobile counterion of another type of charge is provided as an ionic electret. Although the bulk material initially can be electrically neutral, the ionic material is capable of generating and transferring charge upon contact through a process known as contact electrification. Thus-charged materials are used to direct electrostatic self-assembly of surfaces, microspheres or other materials on a micro- or nano-scale.

In another aspect, chemically-modified microspheres are self-assembled to form three-dimensional microstructures. The chemically modified microspheres include an ionic functional group containing an immobilized ion and a mobile counterion. The microspheres are charged by contact electrification of the immobilized ions and mobile counterions. The choice of these ions determines the electrostatic charges that these microspheres acquire through contact before and during the assembly process. The resulting charged materials are used for electrostatic self-assembly, in which oppositely-charged microspheres assemble into uniform spherical microstructures under the influence of electrostatic forces.

In one aspect, the invention provides a method of self-assembling particles, comprising providing a first set of microspheres having a first ionic functional group containing a first immobilized ion and a first mobile counterion; providing a second set of microspheres having a second ionic functional group containing a second immobilized ion and a second mobile counterion, wherein the first immobilized ion has a charge opposite that of the second immobilized ion; and combining the first and second set of microspheres, wherein the oppositely-charged microspheres self-assemble under the influence of electrostatic forces.

In one or more embodiments, the first set of microspheres has a diameter greater than that of the second set of microspheres, and wherein a plurality of microspheres of the second set of microspheres assemble about a microsphere of the first set.

In one or more embodiments, the ionic functional group is located throughout the particle, or the ionic functional group is localized at a surface of the particle.

In another aspect, the invention provides a method of particle self-assembly, comprising providing a surface for self-assembly, said surface comprising a chemical functionality having an immobilized charge; providing a plurality of first particles, the particles comprising an immobilized chemical functionality of a charge opposite that of the substrate; and contacting the first charged particles with the substrate, wherein the first charged particles self-assemble on the substrate.

In one or more embodiment, the surface and the first particles are charged by contract electrification.

In one or more embodiment, the fraction of chemical functionalities carrying a charge is in the range of about 1-25%, or in the range of about 3-10%.

In one or more embodiments, the surface is planar, or the substrate is in the form of a particle, or the substrate particle is hollow.

In one or more embodiments, the ratio of a diameter of the substrate particle and a diameter of an assembled particle is greater than or equal to 3:1, or the ratio is greater than 5:1, or the ratio is greater than 10:1.

In one or more embodiments, the particles assemble substantially into a monolayer.

In one or more embodiments, an amount of particles is in excess of that needed to form a monolayer, or the excess is greater than or equal to about 10-fold by weight.

In one or more embodiments, the surface is selected from the group consisting of organic or inorganic polymers having a covalently bound ionic functional group, or the organic polymer comprises an ionomer, or the inorganic polymer comprises silica or glass.

In one or more embodiments, the chemical functionality of the substrate is in the form of a preselected pattern.

In one or more embodiments, the method further comprises contacting the self-assembled article with a second charged particle, said second charged particle comprising an immobilized chemical functionality of a charge opposite that of the first charged particle, wherein the second charged particles self-assemble on the first charged particles.

In one or more embodiments, the chemical functionality having an immobilized charge of the surface is located in regions of the surface in a selected pattern.

In one or more embodiments, the method further comprises linking the assembled beads to adjacent beads, where the linking is accomplished by annealing, or the linking is accomplished by covalent bonding.

In one aspect, the invention provides a method of self-assembly, comprising providing a surface for self-assembly, said surface comprising a first region comprising a chemical functionality having a negative immobilized charge and a second region comprising a chemical functionality having a positive immobilized charge that is opposite the first charge; providing a plurality of first particles, the particles comprising an immobilized chemical functionality of a positive charge; providing a plurality of second particles, the second particles comprising an immobilized chemical functionality of a negative charge; and contacting the first and second charged particles with the substrate, wherein the first charged particles self-assemble on the substrate.

In another aspect, the invention provides a self-assembled article comprising a surface comprising an chemical functionality having an immobilized charge; and a plurality of particles assembled on the surface of the core, said particles having a surface comprising an immobilized chemical functionality of a charge opposite that of the core.

In one or more embodiments, the assembly of particles forms a monolayer, or the assembly forms a pattern on the surface, or the surface comprises a microsphere, or the assembly of particles forms a pattern on the surface of the microsphere, or the microsphere is hollow.

In one or more embodiments, the surface is selected from the group consisting of organic or inorganic polymers having a covalently bound ionic functional group, or the particle is selected from the group consisting of organic or inorganic polymers having a covalently bound ionic functional group, or the inorganic polymer comprises silica or glass.

In one or more embodiments, the chemical functionality of the surface and/or the particle is immobilized by a covalent bond, or the chemical functionality is an anionic species, or the chemical functionality is a cationic species.

In another aspect, an article comprises a core region of a first immobilized charge; a first self-assembled layer comprising particles of an immobilized charge opposite the core; and a second self-assembled layer comprising particles of the first immobilized charge.

In yet another aspect, an article comprises a substrate comprising a region of immobilized positive charge and a region of immobilized negative charge; a first set of negatively charged particles assembled over the region of positive charge; and a second set of positively charged particles assembled over the region of negative charge.

In one or more embodiments, sequential steps of self-assembly can create multilayered microstructures.

### BRIEF DESCRIPTION OF THE FIGURES

This invention is described with reference to the figures that are described herein, which are presented for the purpose of illustration only and are not intended to be limiting of the invention.

FIG. 1 is a schematic illustration of a contact electrification process.

FIG. 2 shows a schematic representation of the process of self-assembly according to one or more embodiments of the invention.

FIG. 3 shows a schematic illustration of the process of self-assembly using microcontact printing of silanes on a silicon surface using a patterned stamp according to one or more embodiments.

FIG. 4 shows a schematic illustration of the process of self-assembly for preparing glass beads with regions of positive and negative immobilized charge according to one or more embodiments.

FIG. 5 is a schematic illustration of a procedure for patterning silanes on the surface of glass beads according to one or more embodiments.

FIG. 6 is an optical micrograph of a self-assemble structure according to one or more embodiments.

FIG. 7 is an optical micrograph of a self-assemble structure according to one or more embodiments.

FIG. 8 is a pair of histograms showing the measurements of (A) positive and (B) negative charges on individual 200 μm diameter beads.

FIG. 9 illustrates the self-assembly of charge particles in the presence of mixed charges.

FIG. 10 shows histograms of the measurements of charge of three types of silane-functionalized glass microspheres.

### DETAILED DESCRIPTION

The ion-transfer model of contact electrification is used to design microspheres that develop predictable electrostatic charges upon contact with other surfaces. These spheres are then used as components in electrostatic self-assembly. Assemblies form due to the attraction between oppositely-charged microspheres. Contact electrification provides charged components, without the use of expensive equipment such as a high-voltage power supply or an electron-beam gun, and enable the use of large quantities of material or assembly over large areas. Assemblies form rapidly, e.g., within seconds, and in high yield, in some cases in greater than 99.9% yield. The assembled structures are themselves useful as components in multistep self-assembly.

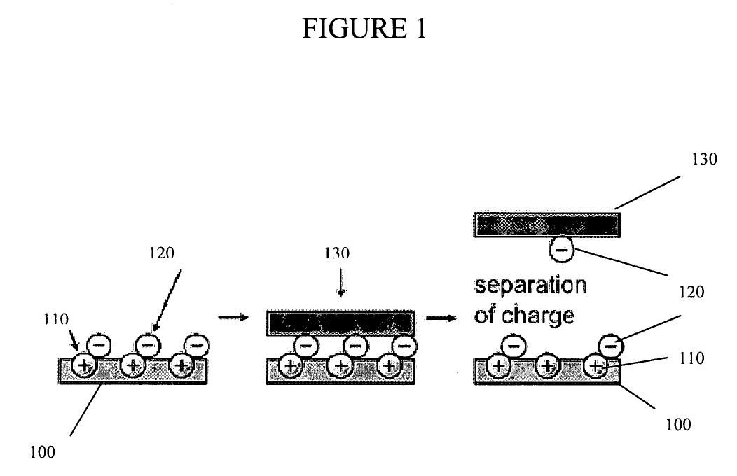

The contact charging of ionomers (polymers with covalently-bound ionic functional groups) is believed to result from the transfer of mobile ions from the ionomer to another material, as shown in FIG. 1. According to FIG. 1, an ionomer 100 with covalently-bound cations 110 transfers some of its mobile counterions 120 to another surface 130 upon contact. The mobile ion, but not the covalently-bound ion, is transferred during contact. This transfer results in a net positive charge on the ionomer, and a net negative charge on the other surface. An ionomer with covalently-bound anions yields the opposite charges.

The charge transfer can occur by simple contact or by friction, e.g., rubbing, of the different materials against one another. In one or more embodiments, the charge-receiving material or surface can be a container housing the charge-transferring materials. Thus, by way of example only, the charge-transferring material can be an ionic bead or particle, and the charge-receiving surface or material can be a beaker or tray containing the beads. Other embodiments can involve shaking with charge-receiving material in or against the charge-receiving surface. Charge transfer is accomplished by agitating or shaking the beads in the container. In other embodiments, the charge transfer material is a surface and the charge is transferred by friction or rubbing.

Since a charged surface is generated by simply rubbing or agitating the surface, it is possible for surfaces of relatively simple to relatively complex morphologies to generate charge. The surface for self-assembly, therefore, can be a flat surface or it can be a sphere, or any other complex shape. In one or more embodiments, the tendency of the materials to charge electrify is sufficiently facile that the simple synthetic work up in preparing the materials and processing them into particles (or other shapes) will effect contact charging. Note that not all of the mobile charges need to be removed in order for the beads (or other surface) to be used for self-assembly according to one or more embodiments of the invention. In one or more embodiments, a few percent, e.g., less than 5%, or less then 3% or less than 2% or less than 1% of the mobile ions are transferred during charge contact. In one or more embodiments, the charge on a bead or surface is proportional to its surface area.

In one or more embodiments, the materials used for self-assembly are materials that contain an immobilized ion and a mobile counterion. Any insulating material that has covalently-bound ions and mobile counterions at its surface can function as an ionic electret. The material can be an organic polymer or an inorganic material, e.g., a glass or ceramic, that is suitably chemically modified to provide immobilized ions and mobile counterions. Exemplary ionomers include appropriately modified forms of poly(styrene), poly(butadiene) and poly(methyl methacrylate); exemplary inorganic materials include glass, silica and silicon. Suitable chemical functional groups include those that form ionic species, e.g., cationic or anionic species, having a counterion that is small and rather mobile. Exemplary cationic immobilized ionic groups include tetravalent ammonium and phosphonium groups, e.g., alkyl, aryl or alkylaryl derivatives thereof. Exemplary anionic immobilized groups include alkyl, aryl or alklyaryl derivatives of sulfonates, phosphates and carboxylates.

Chloromethylated crosslinked polystyrene microspheres offer a versatile matrix on which a variety of ionic functional groups can be generated. The chloride provides a reactive site for introduction of a variety of ionic functional groups. In one embodiment, poly(styrene-co-divinylbenzene) microspheres with covalently-bound tetraalkylammonium functionality (compound 1) may be used to form microspheres having a positively charged immobilized chemical functionality and a mobile anion. In another embodiments, poly(styrene-co-divinylbenzene) microspheres with covalently-bound sulfonate functionality (compound 2) may be used to form microspheres having negatively charged immobilized functionalities and a mobile cation. In still other embodiments, alkyltriphenyl phosphonium (compound 3) or sulfonated azobenzene (compound 4) are used to introduce various ionic functionalities. The degree of substitution can be low, e.g., ˜5-10% of the styrene residues, while still maintaining sufficient ionic character. At low substitution levels, the polystyrene resin remains hydrophobic; however, this does not limit its ability to develop charge. In some embodiments, hydrophilic counterions, e.g., Cl⁻ and Na⁺, as well as hydrophobic counterions, e.g., tetraphenylborate (compound 5) and tetraphenylphosphonium (compound 6) are used. A reaction scheme for preparing the chemically functionalized polystyrenes is shown in Scheme 1. Other ionic groups will be apparent and can be made according to this and other reaction schemes according to one or more embodiments of the invention.

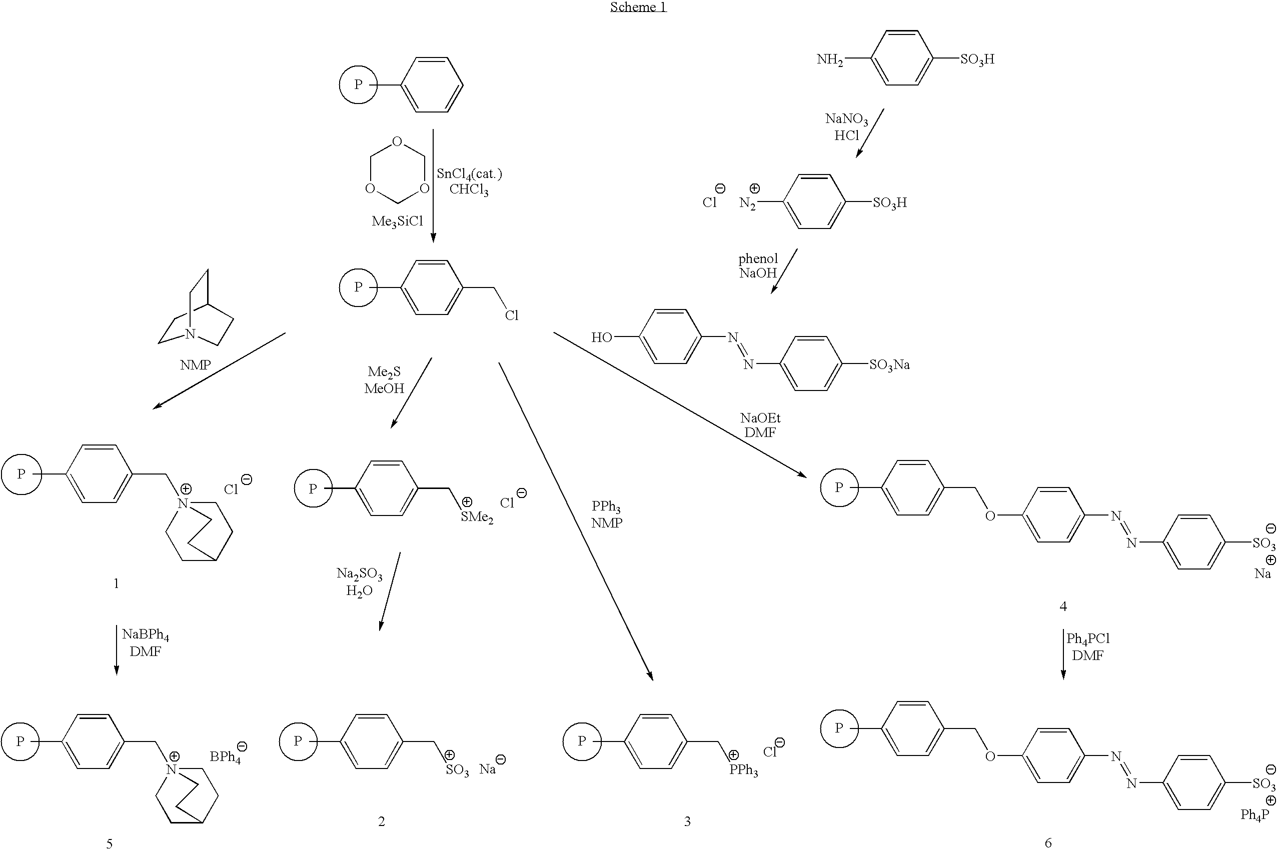

In other embodiments, ionic electrets are prepared from materials other than organic polymers. For example, glass, silica and silicon can be functionalized with silanes containing covalently-bound ions and mobile counterions. In this system the ionic functional groups are confined to the surface, rather than being distributed throughout the bulk of the material. In one or more embodiments, an alkyltrimethylammonium chloride-containing silane can be used to generate a surface with covalently-bound cations, and an alkylsulfonic acid-containing silane can be used to form a surface with covalently-bound anions. Other ionic functional groups may be added using similar methodologies.

The beads diameters can vary and the beads may be solid or hollow. In non-limiting examples, the core and surrounding particles may range from 5 to 200 μm with both types of (positive and negative) functionality. In one or more embodiments, the assembly includes a core bead around which beads of opposite charge are assembled. The core bead may have a diameter at least three times greater than the smaller self-assembling beads. In one or more embodiments, then core bead is at least 5 times, or at least ten times, or at least twenty times, larger in diameter than the smaller beads that self-assemble around it. Larger differences in diameter are also contemplated. While not being bound by any particular theory or mode of operation, it is hypothesized that a diameter ratio of greater than about 3:1 core:assembling particles may be used to avoid repulsion of like-charged particles which may dominate the electrostatic attraction to the core particle as the particle sizes approach one another. For example, extended aggregates have been observed to form with local Coulombic ordering (e.g., (+)(−)(+)(−)) but no long-range order when the two oppositely-charged spheres approach the same size.

The charged beads can be packed for shipment or storage. When a large number of similarly charged particles are stored together, the large charge in small spaces causes the dielectric breakdown of the air and discharges some of the microspheres, so that they can be easily stored and transferred. When ready for use in a self-assembly operation, charge can be regenerated by pouring or shaking the particles in the vial or other container and the charge is restored by contact electrification.

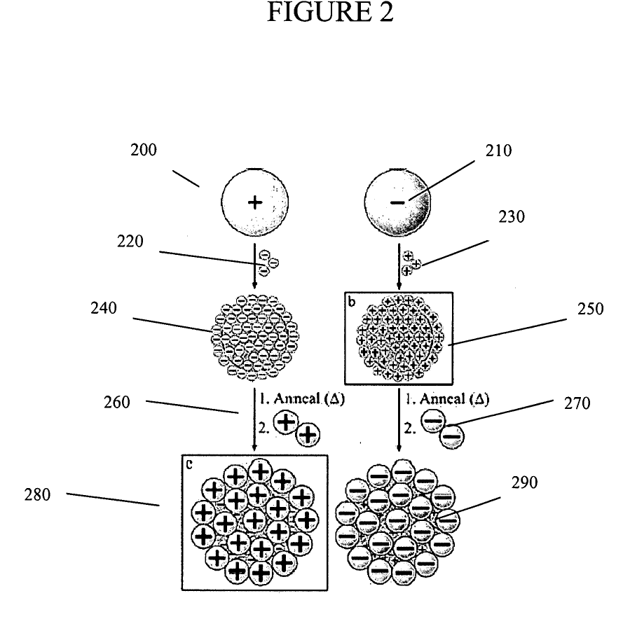

FIG. 2 shows a schematic representation of the process of self-assembly according to one or more embodiments of the invention. Mixtures with either charge combination (i.e. the larger sphere is positively or negatively charged) or with different sizes of microspheres yield similar structures. Larger particles of positive and negative charge 200, 210 are shown in the left and right sides of FIG. 2, respectively. The larger particles are then combined with smaller particles of opposite charge 220, 230, respectively, and are agitated until the particles are thoroughly mixed. The large and small, oppositely charged particles can be added at about 1:1 by weight or an excess of the smaller charged particles may be used. In some embodiments, about 5-fold, or about 10-fold or about 20-fold greater amounts (by weight) of smaller particles can be used. Each of the larger beads is coated with a slightly disordered monolayer 240, 250 of the smaller beads of opposite charge. The coating is essentially a monolayer and exhibits some order, however, some level of defects in the layer may be observed.

Once the beads are assembled, it is possible to “set” the assembly to create a more robust structure by annealing. Heating at elevated temperatures softens the beads and creates necks or sticking at contact points between beads. The anneal temperature will vary depending on the ionomer. It may also be possible to introduce linking mechanisms in a bead during its preparation. Thus, in addition to chemical functionalities containing immobilized anions, the bead may include linking functionalities that can be activated to create chemical links between beads. For example, one bead could have a nucleophilic functional group such as amine or alcohol, and another bead could have an electrophilic functional group such as aldehyde or activated carboxylic ester. Reaction of these two functional groups would yield covalent links between the beads in the form of imines, amides, or esters.

The mechanically more robust assembly may be used in further self-assembly operations. Further self-assembly is facilitated by a charge imbalance that may remain in the self-assembled structure. Referring to FIG. 2, the layered assembly 240, 250 having a monolayer of beads of one charge can be combined with beads 260, 270 of the opposite charge and a second layer 280, 290 is self-assembled in the bead surface. By way of example, an assembly 250 containing a monolayer of positively charged beads can be contacted with negatively charged beads 270 to form a doubly charged layered assembly 290 having a negative core region, a first positively charged self-assembled layer and a second negatively charged self-assembled layer. Additional layers, e.g., 3 or more, are possible.

In a typical experiment, ca. 0.5 mg of dry, 200-μm-diameter sulfonate-functionalized beads (compound 2) is combined with ca. 0.5 mg of dry, 20-(μm-diameter tetraalkylammonium-functionalized beads (compound 1) in an aluminum dish. The dish is agitated until the beads were thoroughly mixed. Within seconds, the 200-μm beads (compound 2) become coated with a slightly disordered monolayer of the 20-μm beads (compound 1). Assemblies were achieved with a combination of beads, some as small as 5-μm and 50-μm bead sizes. The monolayer assemblies were sufficiently stable that they could be rolled on a surface without significant disruption. Heating the assemblies to ca. 260° C. for 10-15 minutes annealed the beads together, and made the assemblies more robust mechanically. After annealing, the composite structures were used as components in a subsequent assembly step to yield multilayered microstructures. See, FIG. 2.

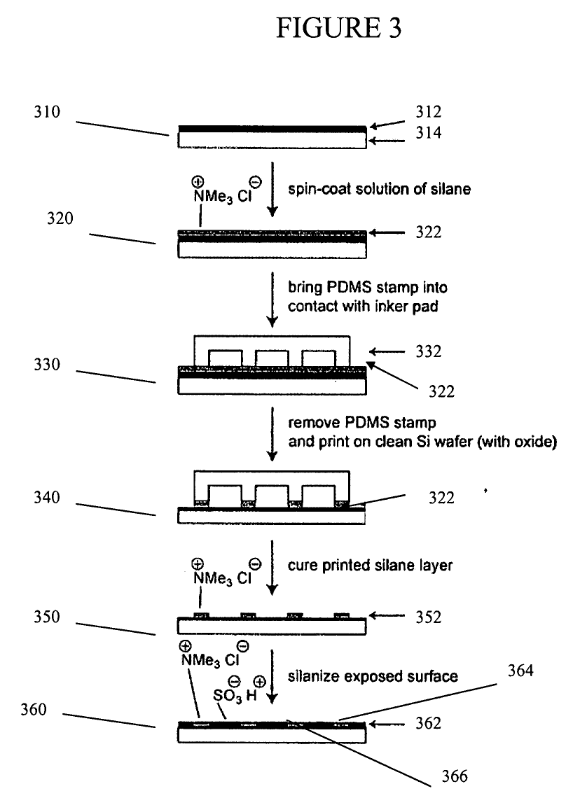

In one or more embodiments, the assembling structure is not limited to beads. Planar and non-planar surfaces may be used to self-assemble charged particles. Charged beads can be assembled on a variety of surfaces, as is illustrated in FIG. 3, by treating the surfaces to generate regions of the appropriate charge. Because the charge arises from immobilized ions, it is possible to create a surface containing regions of positive charge and negative charge and to create assembled layers in those regions.

In one or more embodiments, chemically-modified electrostatic self-assembly can form charged patterns. The chemical functionalities can be arranged on a surface, with bound cations in one region and bound anions in another, so as to yield patterns of charge on that surface. The charged-patterned surface can then be combined with charged microspheres so that the microsphere self-assemble on the charge-patterned surface. Charge pattern can be introduced using conventional patterning methods. Patterns of any type may be used, e.g., geometric, curvilinear, simple and complex. For example and without limitation, silanes can be patterned on oxide surfaces using photolithography, focused ion beams, scanning-probe techniques such as dip-pen nanolithography, and soft lithography.

In one or more embodiments, microcontact printing, a type of soft lithography, is used to pattern silanes on a silicon wafer with thermally-grown oxide (SiO₂) layer. In contact microprinting, a flexible micropatterned stamp is used to pattern a surface by transferring a functionalized silane “ink” onto the silicon surface. Because the electrode is flexible, it can make an intimate contact with the surface and can produce a pattern of uniform charge over the contact area. A flexible micropatterned electrode can be made from a flexible polymer, such as poly(dimethylsiloxane) (PDMS).

FIG. 3 shows a general approach for contact microprinting a surface having regions of different immobilized charges. In step 310, an adhesion layer 312, typically made of gold and/or chromium, is put down over a silicon wafer using conventional methods. In step 320, a solution of alkyltrimethylammonium silane 322 is deposited, for example by spin coating, on the gold layer to create an “ink pad,” which is used to “ink” a topographically-patterned PDMS stamp. In step 330, a PDMS ink stamp 332 is pressed against the alkyltrimethylammonium silane “ink pad” surface 322 and the pattern is transferred onto a clean silica layer (step 340). The silane on the SiO₂ surface is cured at room temperature for two hours to set the positively charged silane regions 352 (step 350). The rest of the surface is then treated with a negatively charged alkylsulfonic acid silane to provide a surface pattern 362 of two different silanes (step 360). The topography of the resultant layer is essentially flat and contains regions of positive (364) and negative (366) charge. The regions with covalently-bound cations had a more positive potential, while the regions with covalently-bound anions had a more negative potential. The net charge in this case most likely results from the loss of some mobile counterions during the preparation and washing of the sample; this may be an example of contact electrification between the solid substrate and the washing liquid (ethanol).

Surfaces that have been patterned as described above can be exposed to microspheres having positive or negative immobilized charges on their surfaces. The negatively charged microspheres self-assemble over the positively charged regions of the surface and the positively charged microspheres self-assemble over the negatively charged regions of the surface.

According to one or more embodiments of the invention, charge patterning is not limited to planar surfaces. Microspheres can be prepared having regions of immobilized negative and positive charges. In one or more embodiment, spheres having approximately a zero overall charge (but a net electric dipole) are provided, in which one hemisphere has bound cations and the other hemisphere has bound anions. In other embodiments, smaller regions of charge are provided. Other patterns are contemplated, for example, where the charged regions are of complex shape and are provided on a sphere or other curved surface. Conventional patterning methods may be used.

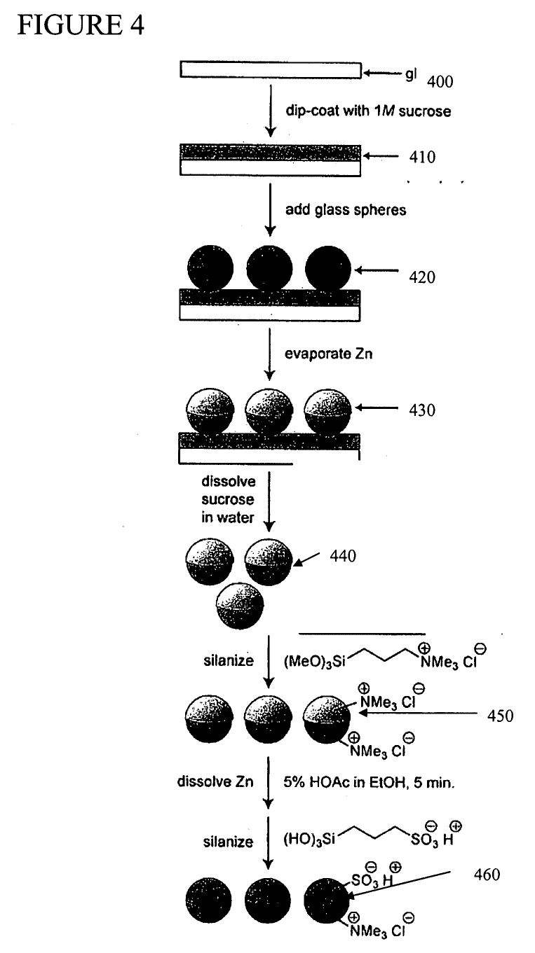

FIG. 4 shows the process used to fabricate “half-and-half glass microspheres.” A glass substrate 400 is dip-coated with sucrose 410 to provide a thin film (˜10 μm), which serves as a base for securing glass microspheres 420 (˜250 μm). A sacrificial layer 430, e.g., of zinc, is deposited on the microspheres to coat half of each sphere. The beads on the sucrose-coated plate are washed in water to dissolve the sucrose and release the beads and provide free beads 440. The beads are then silanized with an alkyltrimethyl ammonium chloride silane to provide a silane-coated bead 450. Although the silane coats the entire bead, the bead is treated with 5% acetic acid in ethanol to dissolve the zinc coating (and its accompanying silanization), thereby exposing half of the glass sphere. The newly-exposed glass surface is then treated with an alkylsulfonic acid silane, to obtain a bead 460 that is coated on one side with positively charged alkyltrimethyl ammonium groups and on the other side with negatively charged alkylsulfonate groups.

The “half-and-half” spheres have approximately zero overall charge. The small charge of these beads confirms our earlier observation that the surface charge density of positively-charged ionic electrets is similar to that of negatively-charged ionic electrets. Preparation of “half-and-half” glass microspheres that acquired no net electrical charge provides new materials that do not develop a net charge upon contact, but develop dipoles or higher multipoles instead.

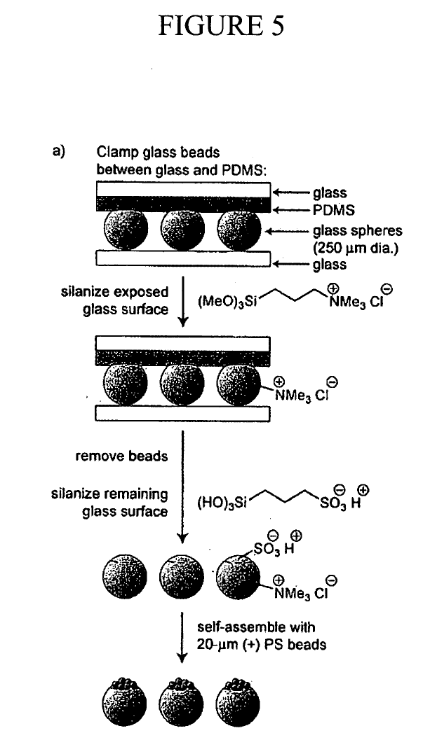

In one or more embodiments, non-planar surfaces such as beads are patterned using lithographic methods. The use of soft materials such as PDMS enables patterning of non-planar surfaces. FIG. 5 illustrates the patterning of 250-um-diameter glass microspheres using soft lithographic methods.

In one exemplary process, a single layer of glass microspheres is secured between a PDMS surface and a glass slide, so that the PDMS conformally contacts a small region around the “north pole” of each sphere. The entire assembly then is immersed in a solution of alkyltrimethylammonium-containing silane. A positively charged silane coating is formed over the glass bead surface, except where the conformal contact of the PDMS prevents the silane from reacting with that region. The beads are then separated from the assembly resulting in a silanized bead with an exposed “north pole” region. The exposed region is treated with an alkylsulfonic acid-containing silane. Smaller charged particles of tetraalkylammonium-functionalized polystyrene were then electrostatically self-assembled to image the region of charge.around the “north pole.” The small microspheres became positively charged by contact electrification and adhered only to the negatively-charged regions of the glass beads, the “north pole” region on each bead

The presence of adsorbed water facilitates the dissipation of charge. Maximum charge may be achieved when the humidity is low, and a suitably functionalized hydrophobic materials are used. In one or more embodiments, assembly may occur under gas environments with a greater dielectric strength than air, such as SF₆, or the under high vacuum (the threshold for field emission in vacuum is about ten times greater than the threshold for dielectric breakdown of air).

The invention is described with reference to the following examples, which are provided for the purpose of illustration only and are not intended to be limiting of the invention well-understood, one can rationally design components to become charged through contact electrification, and use those components for electrostatic self-assembly.

### EXAMPLE 1

### Preparation of Chemically Modified Beads

Chloromethylation of polystyrene beads. 500 mg of crosslinked polystyrene beads (poly(styrene-co-divinylbenzene), 70 μm diameter, Duke Scientific) and 450 mg of s-trioxane were combined in a 20-mL flask. Under nitrogen, 5.0 mL of anhydrous chloroform, 1.9 mL of Me₃SiCl, and 0.3 mL of SnCl₄ were added and the mixture was stirred at room temperature. After 30 minutes, the beads had developed a dark brick-red color. After a total of two hours, the reaction was quenched by adding a mixture of 20 mL of THF and 10 mL of methanol; the color vanished almost immediately. The beads were collected by filtration, washed three times with 30-mL portions of THF, washed twice with 10-mL portions of hexanes, and dried under vacuum at room temperature overnight. A total of 546 mg of slightly off-white beads were collected. Anal. found: C, 86.79; H, 7.58; Cl, 5.87. Based on this analysis, 19% of the styrene residues in the polymer had been chloromethylated, for a degree of functionalization (DF) of 0.19. Polystyrene beads with other diameters (also from Duke Scientific) were functionalized using the same procedure, with the following results: 200 μm, 8.87% Cl by mass (DF=0.30); 100 μm, 5.92% Cl (DF=0.19); 50 μm, 6.96% Cl (DF=0.23); 25 μm, 7.04% Cl (DF=0.23); 20 μm, 5.46% Cl (DF=0.17); 5 μm, 7.56% Cl (DF=0.25).

Preparation of tetraalkylammonium beads (compound 1). To 10 mL of N-methylpyrrolidinone (NMP) was added 100 mg of chloromethylated polystyrene beads and 56 mg of quinuclidine. The mixture was stirred at room temperature overnight. The beads were collected by filtration, washed twice with 20-mL portions of ethanol, twice with 20-mL portions of DMF, three times with 20-mL portions of THF, and three times with 20-mL portions of ethanol. (Ethanol does not swell the polystyrene resin, while DMF and THF do; this sequence of washes was used in order to rinse the beads, swell them, remove polar contaminants with DMF and nonpolar contaminants with THF, and then deswell the beads back to their original size.) The resulting colorless beads were dried in an oven at 60° C. and stored in a glass vial under ambient conditions. Anal. found (200-μm beads): C, 80.26; H, 7.59; N, 1.15; Cl, 7.67. The observed N content suggests that the reaction with quinuclidine was only ca. 40% complete. We note that the crosslinked polystyrene purchased from Duke Scientific is ˜10% crosslinked, whereas typical solid-phase synthesis resins are ˜1% crosslinked. The highly-crosslinked beads swell in NMP to only ˜1.5 times their volume, while the usual beads swell to about 10 times their volume. Our bulk yields tended to be low as a result.

Preparation of sulfonate beads (compound 2). Chloromethylated polystyrene was sulfonated allowing chloromethylated polystyrene beads to react with dimethylsulfide in methanol to yield the resin-bound sulfonium salt. This resin was sufficiently polar that it could be swelled with aqueous sodium sulfite; the sulfite substituted for the dimethylsulfonium moiety, yielding the resin-bound sulfonate. IR (KBr): vs=o 1179 and 1037 cm-1. Anal, found: C 79.09, H 7.41, S 3.34.

Preparation of Alkyltriphenylphosphonium Beads, 3. To 10 mL of N-methylpyrrolidinone (NMP) was added 100 mg of chloromethylated polystyrene beads and 200 mg of triphenylphosphine. The mixture was stirred at 100° C. for 5 days. The beads were collected by filtration, washed twice with 20-mL portions of ethanol, twice with 20-mL portions of DMF, three times with 20-mL portions of THF, and three times with 20-mL portions of ethanol. The resulting colorless beads were dried in an oven at 60° C. and stored in a glass vial under ambient conditions. IR (KBr): v_{P-Ph} 1018 and 1110 cm⁻¹. Anal. found: C 82.84, H 7.01, P 0.48. The low P content suggests that the reaction was only ˜20% complete. The reaction of triphenylphosphine with chloromethylated polystyrene is known to be quite slow, and the crosslinked polystyrene purchased from Duke Scientific is ˜10% crosslinked, whereas typical solid-phase synthesis resins are ˜1% crosslinked. The highly-crosslinked beads swell in NMP to only ˜1.5 times their volume, while the usual beads swell to about 10 times their volume. The high degree of crosslinking may have prevented the bulky triphenylphosphine nucleophile from reacting throughout the bead.

Preparation of azo-sulfonate beads (compound 4). To 10 mL of DMF was added 100 mg of chloromethylated polystyrene beads and 40 mg (120 mmol) of sodium 4-hydroxyazobenzene-4′-sulfonate (prepared by a literature procedure). The resulting yellow solution turned orange upon the addition of 0.04 mL (110 mmol) of 2.7 M sodium ethoxide in ethanol. The mixture was stirred at 100° C. overnight. The beads were collected by filtration, washed twice with 20-mL portions of water, twice with 20-mL portions of DMF, three times with 20-mL portions of THF, and three times with 20-mL portions of ethanol. The resulting orange beads were dried in an oven at 60° C. and stored in a glass vial under ambient conditions. Anal. found (200-μm beads): C, 83.65; H, 7.29; N, 0.58. The low N content suggests that the reaction was only ca. 10% complete. IR (KBr): v_{N═N} 1369 cm⁻¹; vₛ₌₀ 1180 and 1029 cm⁻¹. The azobenzene moiety in the azo-sulfonate beads imparts an orange color to those beads.

### EXAMPLE 2

### Self-Assembly of Chemically Modified Beads

The beads of interest were combined in an aluminum dish with a diameter of 5 cm. Typically, large beads with one type of charge were combined with smaller beads with the other charge. The dish was tapped with a metal spatula ca. 20-50 times until the beads were thoroughly mixed. Each large bead became coated with a monolayer of the oppositely-charged small beads. These assembled structures were then poured out of the dish. Experiments using a gold-coated glass dish and an aluminum dish yielded indistinguishable results. Attempts at assembly in uncoated glass dishes or polystyrene Petri dishes were less successful: these electrically insulating surfaces appeared to develop local regions of charge—“hot spots”—on which the beads adhered.

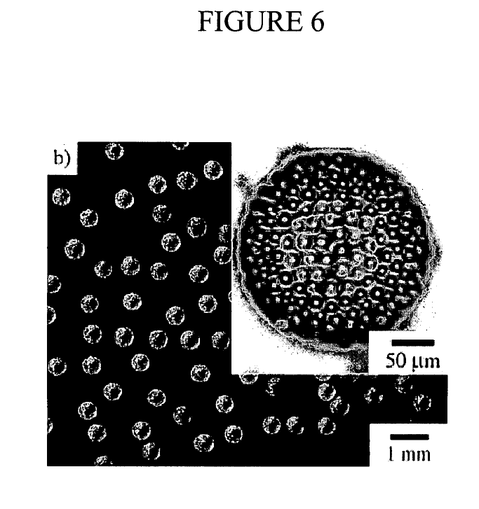

To achieve uniform coverage of the large spheres, an excess of the small spheres (at least 10 times more than would be needed for monolayer coverage) were used. Such excess was necessary because some of the small spheres adhered to the surface of the dish rather than adhering to the large spheres. Thus, the large spheres were considered in these experiments to be the “limiting reactant” in the system. The yield of the experiments was determined by identifying on each large sphere any vacant areas large enough to bind a small sphere; each such defect was considered to be a site of incomplete “reaction” of the small spheres with the large sphere. FIG. 6 is an optical micrograph of a structure resulting from the assembly of 200 μm diameter positively charged beads and 20 μm diameter negatively charged beads. In the large-field image shown in FIG. 6, there were 100 complete assemblies (including those hidden by the inset), each with about 100 visible small spheres. Only six vacant sites in the entire image were observed, for a yield of greater than 99.9%.

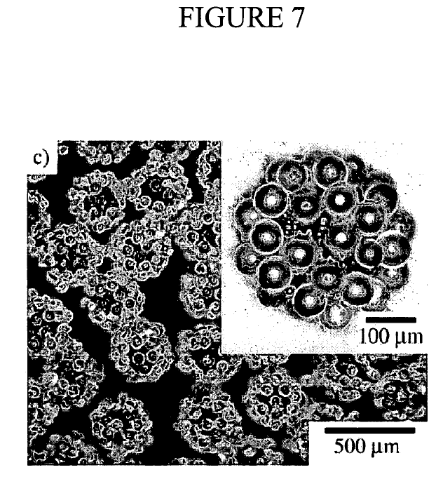

For the multistep self-assembly experiments, the assembled structures from the first step were transferred to a clean aluminum dish, heated in an oven at ca. 260° C. for 10-15 minutes, and allowed to cool to room temperature. The next layer of beads was added to the annealed assemblies and the same process of self-assembly was performed. FIG. 7 is an optical micrograph of a structure resulting from the assembly of 200 μm diameter positively charged spheres and 20 μm diameter negatively charged spheres and 70 μm diameter positively charged spheres.

### EXAMPLE 3

### Measurement of Bead Charge

Beads prepared in Example 1 were placed in an aluminum dish with a diameter of 5 cm. A mechanical shaker shook the dish at approximately 10 Hz for at least 5 minutes; the motion of the dish caused the beads to roll around in the dish. The same charge measurements were obtained whether the aluminum dish was grounded, insulated, or biased at either +10 kV or −10 kV with a high-voltage DC power supply (Spellman). The fact that the bead charge was insensitive to the electrical potential of the dish suggests that the charging of these beads is due to ion transfer and not electron transfer.

The charge on each bead was measured using the following apparatus: A polyethylene tube (2 mm diameter) was connected to a vacuum source and threaded through 3 concentric aluminum cylinders. The three concentric cylinders were approximately 4, 9, and 30 mm in diameter and 1.0, 1.1, and 1.4 meters in length, respectively. Concentric solid polyethylene tubing insulated the cylinders from each other. The three cylinders were soldered to the three leads of a triaxial shielded cable (Belden 9222), with the innermost cylinder connected to the central lead; these connections were all enclosed within the outermost shielding cylinder. This shielding configuration was necessary in order to make measurements with low noise (RMS noise ˜20 fC) and minimal background drift. The triaxial cable was connected directly to a Keithley model 6514 electrometer in charge-measurement mode: in this mode, the instrument acts as a current integrator. The total charge (time integral of the current) was recorded 60 times per second on a computer connected to the electrometer.

In charge-measurement mode, the electrometer maintains the two innermost aluminum cylinders at the same electrical potential. The vacuum drew air through the central polyethylene tube. When the end of the tube was brought close to a small bead, the flow of air drew the bead into the tube. As the bead passed into the innermost metal cylinder, any charge on the bead induced on the cylinder an equal charge, which was detected by the electrometer. For instance, if a positive bead entered the cylinder, the electrometer reading would increase by an amount equal to the charge on the bead. Once the bead exited the cylinder, the induced charge vanished and the electrometer reading would return, on average, to its initial value. Each positive bead thus gave an upward-pointing peak on the electrometer trace, while each negative bead gave a downward-pointing trough.

Each peak or trough was not exactly symmetrical: the charge on the bead when it entered the tube was not the same as the charge on the bead when it exited the tube. The flow of air in the tube is turbulent (Reynolds number ˜6000), so the bead will inevitably collide with the walls of the tube. Presumably, contact electrification between the bead and the polyethylene tube changed the charge of the bead. The difference between those two charge measurements, however, was not statistically significant for either sample of beads. We measured the charges on 44 individual tetraalkylammonium beads and 40 individual sulfonate beads. A paired t-test for the mean difference did not show statistical significance at a 95% confidence level, and the 95% confidence interval for the mean difference was, in both cases, smaller than the standard deviation of the bead charge. We took the charge on each bead to be that measured as the bead entered the tube, to minimize any effects of interactions with the polyethylene.

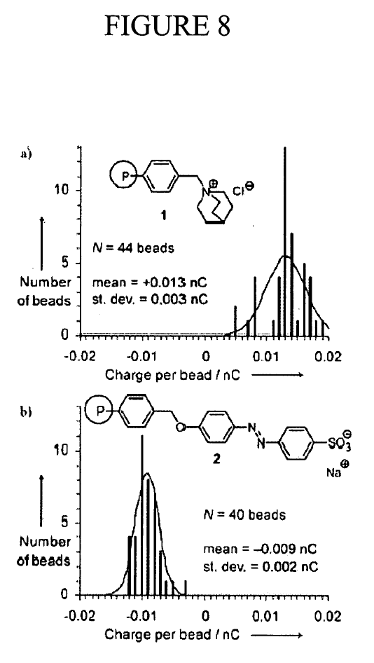

FIG. 8 shows histograms of charge measurements of 200-μm beads with each type of functionality. All of the beads with the tetraalkylammonium functionality were positively charged, while all of the beads with the sulfonate functionality were negatively charged. Assuming that the charge is uniformly distributed on the surface of each bead, the magnitude of charge (ca. 0.01 nC per bead) corresponds to approximately one elementary charge per 2000 nm². Since the density of ionic functional groups on the surface of each bead is probably on the order of one functional group per 10 nm², only ca. 0.5% of the mobile ions on the bead surface are transferred during contact electrification.

### EXAMPLE 4

### Demonstration that the Self-Assembly is Due to Electrostatic Interactions

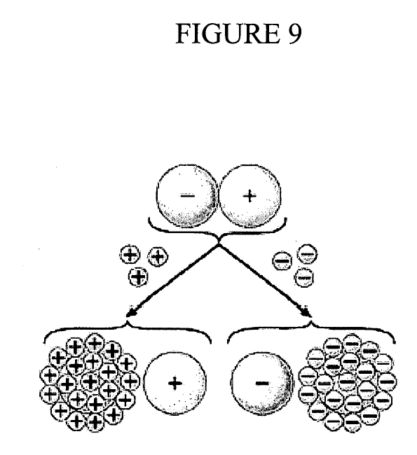

Microspheres of different sizes and charges were combined as shown schematically in FIG. 9. An excess of 20-μm-diameter positively-charged spheres were added to a mixture of both positively-charged and negatively-charged 200-μm-diameter spheres. The small spheres coated only those large spheres with the opposite charge, while the like-charged spheres remained uncoated.

Small negatively-charged spheres were added to a similar mixture of large spheres. Again, the small spheres coated only those large spheres with the opposite charge. The same results were obtained regardless of the order in which the three batches of spheres were combined. Gentle agitation of some of the self-assembled structures while exposing them to ionized air from an anti-static gun (Zerostat) resulted in structures disassembling into individual microspheres.

### COMPARATIVE EXAMPLE

For the control experiments, 200-μm-diameter polystyrene beads and 20-μm-diameter polystyrene beads (Duke Scientific) were washed with water, DMF, THF, and ethanol according to the same protocol used for the functionalized beads, dried in an oven at 60° C., and stored in a glass vial under ambient conditions. These cleaned beads were combined in an aluminum dish and self-assembly was attempted following the protocol described above. Almost no adhesion was observed between these unfunctionalized beads.

### EXAMPLE 5

### Silanization of Chemically Modified Glass Beads

Glass microspheres (250-μm diameter, Supelco) were immersed in a 10% solution of the desired silane (Gelest) in 95% ethanol. The solution was adjusted to pH ˜5 with acetic acid. After 10 minutes, the beads were rinsed once with ethanol and heated at 60° C. for at least one hour. The beads were then rinsed three times with ethanol and dried at 60° C. The silanes were N-trimethoxysilylpropyl-N,N,N-trimethylammonium chloride and 3-(trihydroxysilyl)-1-propanesulfonic acid.

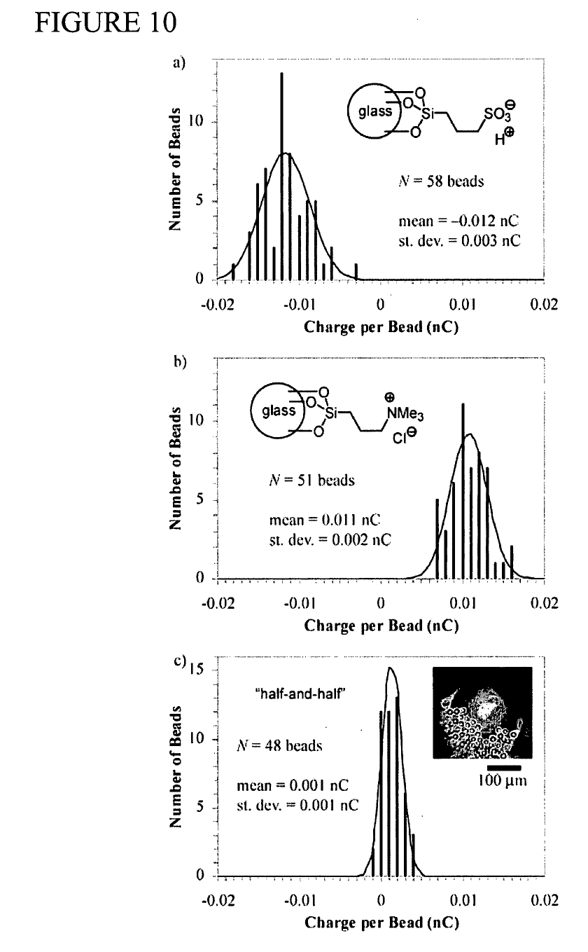

FIG. 10 shows histograms of the measurements of charge of these silane-functionalized glass microspheres. As predicted by the ion-transfer mechanism, the spheres with bound cations all charged positively, while the spheres with bound anions all charged negatively. The surface charge density (about one elementary charge per 2000 nm²) was similar to that of the polystyrene-based ionic electrets.

### EXAMPLE 6

### Fabrication of “Half-and-Half” Glass Beads

A glass microscope slide was dip-coated with a 1M aqueous solution of sucrose and dried at 60° C. for 20 minutes. The dry sucrose film was made tacky by moistening it slightly with water vapor from exhaled breath. Glass microspheres (250-μm diameter, Supelco) were poured onto the surface; a single layer of beads adhered to the tacky sucrose film (the beads did not appear to sink into the film). A thin film of zinc (˜70 nm) was evaporated thermally onto the glass microspheres. The half-zinc-coated beads were released by dissolving the sucrose in water.

The beads were washed with ethanol, silanized with TV-trimethoxysilylpropyl-N,N,N-trimethyammonium chloride (10% in ethanol, no acid added), and heated at 60° C. for at least one hour. The beads were treated for 10 minutes with an ethanolic solution containing 10% 3-(trihydroxysilyl)-1-propanesulfonic acid and 5% acetic acid. This solution was sufficiently acidic to dissolve the zinc (˜5 min); it also served to silanize the newly-exposed glass surface. The beads were washed once with ethanol and dried at 60° C. FIG. 10 shows a histogram of the charge of these beads, indicating that the overall charge was close to “zero.”

### EXAMPLE 7

### Patterning of Silanes on a Silicon Surface

Silanes were printed on a silicon oxide surface (with oxide) using microcontact printing. Poly(dimethylsiloxane), PDMS (Dow Corning, Sylgard 184) was poured over a photolithographically-fabricated master. After curing at 65° C. for two hours, the PDMS was oxidized in an oxygen plasma for ˜60 s and silanized with the desired silane (1% N-trimethoxysilylpropyl-N,N,N-trimethylammonium chloride in 95% ethanol:water). The stamp was washed thoroughly with ethanol and dried with a stream of N₂. An 0.05% solution of the same silane in ethanol was spin-coated on a gold “inker pad” 63 (a silicon wafer with ˜5 nm of Cr and ˜70 nm of Au) at 3000 rpm for 30 seconds. The silanized PDMS stamp was “inked” by contact with this “inker pad” for 60 seconds. The stamp was then placed for 30 seconds on a plasma-cleaned silicon wafer with a ˜300 nm thermally-grown oxide layer (Universitywafer.com). This silanized wafer was allowed to sit at room temperature for 2 hours and then immersed in a 1% solution of 3-(trihydroxysilyl)-1-propanesulfonic acid in 95% ethanol:water for 10 minutes. The wafer was washed thoroughly with ethanol and dried with a stream of N₂.

### EXAMPLE 8

### Patterning of Silanes on Glass Microspheres

A glass microscope slide was coated with a ˜1 mm layer of PDMS (Sylgard 184, Dow Corning). Glass microspheres (250-μm diameter, Supelco) were clamped between this PDMS-coated slide and a plain glass microscope slide. The PDMS conformed to a small spot around the “north pole” of each sphere. The spheres were immersed in a solution of N-trimethoxysilylpropyl-N,N,N-trimethylammonium chloride (10% in ethanol, adjusted to pH˜5 with acetic acid) for 10 minutes. The spheres were washed once with ethanol and the silane layer cured at 60° C. for one hour. The beads were removed, washed again with ethanol, and silanized with a solution of 3-(trihydroxysilyl)-1-propanesulfonic acid (10% in ethanol, adjusted to pH˜5 with acetic acid). The beads were washed three times with ethanol and dried at 60° C.

### EXAMPLE 9

### Self-Assembly on Glass Microspheres with Patterned Charge

Approximately 0.5 mg of 20-μm-diameter polystyrene microspheres with tetraalkylammonium functionality were combined with ca. 30 of the glass microspheres with patterned surface charge prepared according to Example 8. The dish was agitated manually for 30 seconds. Most of the glass spheres had a small “clump” of 20-μm beads adhered (as shown in FIG. 1 lb); about a quarter of the glass spheres had no beads adhered.

As will be apparent to one of ordinary skill in the art from a reading of this disclosure, the present invention can be embodied in forms other than those specifically disclosed above. The particular embodiments described above are, therefore, to be considered as illustrative and not restrictive. In addition, the invention includes each individual feature, material and method described herein, and any combination of two or more such features, materials or methods that are not mutually inconsistent.

What is claimed is:

1. A method of self-assembling particles, comprising:
providing a first set of microspheres having a first ionic functional group containing a first immobilized ion and a first mobile counterion;
providing a second set of microspheres having a second ionic functional group containing a second immobilized ion and a second mobile counterion, wherein the first immobilized ion has a charge opposite that of the second immobilized ion;
combining the first and second set of microspheres, wherein the oppositely-charged microspheres self-assemble under the influence of electrostatic forces.

2. The method of claim 1, wherein the first set of microspheres has a diameter greater than that of the second set of microspheres, and wherein a plurality of microspheres of the second set of microspheres assemble about a microsphere of the first set.

3. The method of claim 1, wherein the ionic functional group is located throughout the particle.

4. The method of claim 1, wherein the ionic functional group is localized at a surface of the particle.

5. A method of particle self-assembly, comprising:
providing a surface for self-assembly, said surface comprising a chemical functionality having an immobilized charge;
providing a plurality of first particles, the particles comprising an immobilized chemical functionality of a charge opposite that of the substrate; and
contacting the first charged particles with the substrate, wherein the first charged particles self-assemble on the substrate.

6. The method of claim 5, wherein the surface and the first particles are charged by contract electrification.

7. The method of claim 5, wherein the fraction of chemical functionalities carrying a charge is in the range of about 1-25%.

8. The method of claim 5, wherein the fraction of chemical functionalities carrying a charge is in the range of about 3-10%.

9. The method of claim 5, wherein the surface is planar.

10. The method of claim 5, wherein the substrate is in the form of a particle.

11. The method of claim 10, wherein the substrate particle is hollow.

12. The method of claim 10, wherein the ratio of a diameter of the substrate particle and a diameter of an assembled particle is greater than or equal to 3:1.

13. The method of claim 12, wherein the ratio is greater than 5:1.

14. The method of claim 12, wherein the ratio is greater than 10:1.

15. The method of claim 5, wherein the particles assemble substantially into a monolayer.

16. The method of claim 15, wherein an amount of particles is in excess of that needed to form a monolayer.

17. The method of claim 16, wherein the excess is greater than or equal to about 10-fold by weight.

18. The method of claim 5, wherein the surface is selected from the group consisting of organic or inorganic polymers having a covalently bound ionic functional group.

19. The method of claim 18, wherein the organic polymer comprises an ionomer.

20. The method of claim 18, wherein the inorganic polymer comprises silica or glass.

21. The method of claim 5, wherein the chemical functionality of the substrate is in the form of a preselected pattern.

22. The method of claim 5, further comprising:
contacting the self-assembled article with a second charged particle, said second charged particle comprising an immobilized chemical functionality of a charge opposite that of the first charged particle, wherein the second charged particles self-assemble on the first charged particles.

23. The method of claim 5, wherein the chemical functionality having an immobilized charge of the surface are located in regions of the surface in a selected pattern.

24. The method of claim 5, further comprising linking the assembled beads to adjacent beads.

25. The method of claim 24, wherein the linking is accomplished by annealing.

26. The method of claim 24, wherein the linking is accomplished by covalent bonding.

27. A method of self-assembly, comprising:
providing a surface for self-assembly, said surface comprising a first region comprising a chemical functionality having a negative immobilized charge and a second region comprising a chemical functionality having a positive immobilized charge that is opposite the first charge;
providing a plurality of first particles, the particles comprising an immobilized chemical functionality of a positive charge;
providing a plurality of second particles, the second particles comprising an immobilized chemical functionality of a negative charge; and
contacting the first and second charged particles with the substrate, wherein the first charged particles self-assemble on the substrate.

28. A self-assembled article comprising:
a surface comprising an chemical functionality having an immobilized charge; and
a plurality of particles assembled on the surface of the core, said particles having a surface comprising an immobilized chemical functionality of a charge opposite that of the core.

29. The article of claim 28, wherein the assembly of particles forms a monolayer.

30. The article of claim 28, wherein the assembly forms a pattern on the surface.

31. The article of claim 28, wherein the surface comprises a microsphere.

32. The article of claim 28, wherein the assembly of particles forms a pattern on the surface of the microsphere.

33. The article of claim 32, wherein the microsphere is hollow.

34. The article of claim 28, wherein the surface is selected from the group consisting of organic or inorganic polymers having a covalently bound ionic functional group.

35. The article of claim 28, wherein the particle is selected from the group consisting of organic or inorganic polymers having a covalently bound ionic functional group.

36. The article of claim 35, wherein the inorganic polymer comprises silica or glass.

37. The article of claim 28, wherein the chemical functionality of the surface and/or the particle is immobilized by a covalent bond.

38. The article of claim 37, wherein the chemical functionality is an anionic species.

39. The article of claim 37, wherein the chemical functionality is a cationic species.

40. An article comprising:
a core region of a first immobilized charge;
a first self-assembled layer comprising particles of an immobilized charge opposite the core; and
a second self-assembled layer comprising particles of the first immobilized charge.

41. An article comprising:
a substrate comprising a region of immobilized positive charge and a region of immobilized negative charge;
a first set of negatively charged particles assembled over the region of positive charge and
a second set of positively charged particles assembled over the region of negative charge.
